(19) United States
(12) Patent Application Publication
(10) Pub. No.: US 2003/0041536 A1
(43) Pub. Date: Mar. 6, 2003

(54) Transparent/tinted/translucent window frame system

(76) Inventor: Frank J. Tortorella JR., Park Ridge, IL (US)

Correspondence Address: McAndrews, Held & Malloy, Ltd., 34th Floor, 500 W. Madison Street, Chicago, IL, 60661, US

(21) Appl. No.: 09/944,542

(22) Filed: Aug. 31, 2001

(51) Int. Cl. E06B 1/04; E04C 2/38

(52) U.S. Cl. 52/204.1; 52/204.5; 52/204.59; 52/656.2; 52/656.5

(57) ABSTRACT

A window frame system with transparent, tinted, or translucent window frames is provided. The window frame itself is transparent, tinted, or translucent, instead of merely the enclosed glass window. Because the frame of the window is light permeable, additional light may pass through the window frame yielding an increase in the overall brightness of the window. Additionally, the structural and environmental integrity of the window is preserved because the window frame remains solid. A transparent screen may also replace a conventional screen to further increase light transmission.

### CROSS-REFERENCE TO RELATED APPLICATIONS

Not applicable

### STATEMENT REGARDING FEDERALLY SPONSORED RESEARCH AND DEVELOPMENT

Not applicable.

### BACKGROUND OF THE INVENTION

The present invention generally relates to a system for transparent or tinted window framing systems. More particularly, the present invention relates to a window framing system in which the window frame itself, instead of merely the window, is transparent, translucent, or tinted.

Windows have been employed in the exterior walls of structures, such as dwellings for example, for hundreds of years. Windows may serve many uses, such as providing for ventilation, but one of the main advantages of windows is the admission of natural light into the interior of a structure. Light passing through a window may be useful for practical purposes, such as to provide illumination to the interior of the structure, or may additionally be useful to increase the aesthetic appeal of the window.

A typical window may be employed as part of a wall in a residential, commercial, or industrial structure. The window includes an exterior frame set into the wall, a transparent portion, such as glass, and an interior frame supporting the transparent portion within the exterior frame. The interior frame may be movable within the exterior frame to allow the window to be opened. Many alternatives to the typical window exists, for example, double hung windows which may include two interior frames, each including a transparent portion and each movable within the exterior frame.

In the present day, most window frames are fashioned by extrusion of metal, such as aluminum for example, wood, or a plastic material, such as vinyl or polyvinyl chloride (PVC) for example. Most recently, PVC has become an especially popular material for window frame construction because PVC is white, opaque, UV-stable, and easy to manufacture and process. Also, very recently, some manufacturers have begun to employ injection molding processes to manufacture window frames. However, these techniques also typically employ PVC because of its above-noted properties and its tradition of use in the industry. PVC may be either extruded or injection molded to form articles in any of a number of colors, but the formed articles, although colored, are opaque.

Although many embodiments of window frames may be employed, one important characteristic of most window frame systems is the amount of light that penetrates the window into the interior of the structure. Typically, windows allowing more light to penetrate into the interior of the structure provide brighter illumination and are often more desirable by consumers. Some techniques employed in the industry to increase total light penetration through a window include increasing the transparency of the window or shrinking the size of the window frame. However, both the transparency of the window and the size of the frame have practical limitations, such as structural stability, the necessity to attach to the surrounding wall, or the enclosure of opening or locking components which may provide a bottom limit for the size of the window frame. Additionally, many windows employ screens which may also serve to reduce the light transmitted through the window.

Thus, a window system that provides for additional light penetration has long been desired commercially, by consumers and, therefore, by manufacturers as well. More particularly, a window system providing additional light penetration while maintaining structural stability, environmental sealing, and aesthetic merit has long been desired.

### SUMMARY OF THE INVENTION

A preferred embodiment of the present invention includes a non-opaque window framing system. The window framing system may be transparent, translucent, or tinted. In a preferred embodiment, the window frame itself may be transparent, translucent, or tinted. Because the window frame is light permeable, additional light may enter the interior of the structure. However, the structural integrity of the window is not compromised because the window frame remains solid and sturdy. Additionally, a transparent screen may be employed in the window frame to further increase light penetration.

Preferably the window framing system of the present invention is formed using injection molding. Alternatively, the window framing system of the present invention may be formed using extrusion. Preferably, the transparent material of the window framing system may be transformed into translucent material through the use of color additives. Alternatively, the transparent material of the window framing system may be tinted using color additives. The window framing system may be composed of a plastic material, such as LEXAN polycarbonate or nylon, for example.

These and other features of the present invention are discussed or apparent in the following detailed description of the preferred embodiments of the invention.

### BRIEF DESCRIPTION OF THE DRAWINGS

FIG. 1 illustrates a perspective view of a non-opaque hopper vent according to a preferred embodiment of the present invention.

FIG. 2 illustrates several embodiments of non-opaque window framing systems for windows and doors according to the present invention.

FIG. 3 illustrates additional embodiments of non-opaque window framing systems for windows and doors according to the present invention.

### DETAILED DESCRIPTION OF THE PREFERRED EMBODIMENTS

In describing a preferred embodiment of the present invention as illustrated in the accompanying drawings, specific terminology, such as top, bottom, left, right, interior and exterior, for example, will be utilized for the sake of clarity. However, the invention is not intended to be limited to the specific terms so selected, and it is to be understood that each specific term includes a multitude of equivalents.

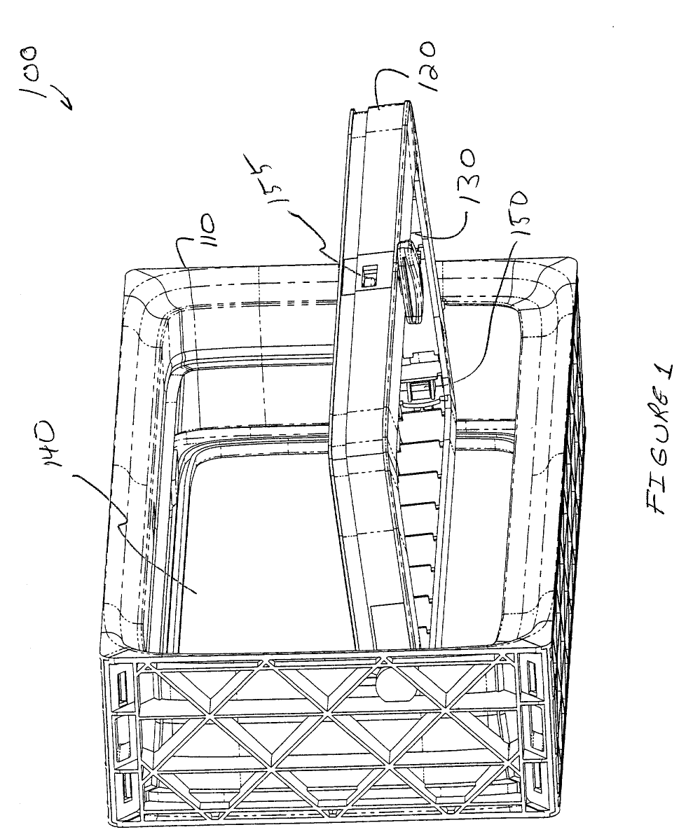

The preferred embodiments of the present invention relate to a window framing system, such as a hopper vent, for example. FIG. 1 illustrates an interior perspective view of a non-opaque hopper vent 100 according to a preferred embodiment of the present invention. The hopper vent 100 includes an exterior frame 110, an interior frame 120, a transparent insert 130, and a screen 140. The hopper vent 100 also includes a window lock 155 and a window spring 150. In the preferred embodiment of FIG. 1, the window lock 115 secures the interior frame 120 to the exterior frame 110 and the window spring 150 aids in the positioning of the interior frame 120 within the exterior frame 110. The exterior frame 110 and interior frame 120 are preferably comprised of four injection molded pieces which may be snapped together to form the exterior frame 110 and the interior frame 120.

As shown in FIG. 1, the exterior frame 110 of the hopper vent 100 may be attached to a surrounding glass block window, for example. The exterior frame 110 encloses and is attached to the interior frame 120. The interior frame encloses and supports the transparent insert 130. The screen 140 is removably fixed to the top and bottom of the exterior frame 110.

In a conventional hopper vent, light passes only through a transparent window mounted in an opaque frame. In the hopper vent 100 of FIG. 1, light passes through the transparent insert 130, but also passes through the exterior frame 110 and interior frame 120 directly because the frames 110-120 are also transparent. That is, in a preferred embodiment, the hopper vent 100 is light permeable, and light is able to substantially pass through the exterior frame 110 and interior frame 120, as well as the insert 130.

The structure of the hopper vent 100 is further described in great detail in a pending patent application entitled “Improved Hopper Vent” which was filed on Aug. 17, 2000, and is incorporated herein by reference in its entirety.

In practice, the hopper vent 100 may be included as part of a glass block window typically located as part of an exterior wall of a structure and separating the interior of the structure from the exterior of the structure. The glass block window, and thus also the present invention, may then be understood to include an interior side, viewable from inside the structure, and an exterior side viewable from outside the structure.

In general, the light permeable hopper vent 100 is composed of a transparent, translucent, or tinted material, such as LEXAN polycarbonate or NYLON, for example, although other materials may be employed, and is preferably injection molded. That is, the exterior frame 110, interior frame 120, and screen 140 are composed of the transparent, translucent, or tinted material, but may include additional elements such as the window lock 155 or the window spring 150, for example, which may be composed of the transparent, translucent, or tinted material, or may alternatively be a non-opaque material such as a metal, for example. The transparent insert 130 is preferably composed of a transparent material, such as glass or other glazing material, for example.

In a typical injection molding process, plastic material, such as powders or pellets of plastic, for example, is mixed and heated until the plastic material liquefies. Next, the liquefied plastic material is introduced into a shaped mold. Then, the mold is allowed to cool. As the mold cools, the liquefied plastic material solidifies and conforms to the shape of the mold.

In a typical extrusion process, plastic material, such as powders or pellets of plastic, for example, is mixed and heated until the plastic material partially liquefies. The partially liquefied plastic material then passes through a die, and lengths of the material are extruded and then cut. The cut lengths of material may then be further manufactured into a desired article.

Because the hopper vent 100 is substantially manufactured from a transparent, translucent, or tinted material, such as LEXAN polycarbonate or NYLON, for example, the hopper vent 100 is transparent when completed through injection molding, extrusion, or other such process. Alternatively, the hopper vent 100 may be tinted to any of a variety of colors through the addition of a commercially available color additive, such as polycarbonate coloring additive to the LEXAN polycarbonate, for example, prior to injection molding. For example, a powdered color additive may be added to the plastic powder and then mixed and heated. Additionally, the transparency of the hopper vent 100 may be altered through the addition of other commercially available additives, such as polycarbonate additives to the LEXAN polycarbonate, for example, prior to injection molding. Alternatively, color additives or other additives may be added to extruded plastic material as well.

The preferred embodiment of the present invention is injection molded rather than extruded. As shown in FIG. 1 and described above, the hopper vent 100 may be simply and easily snapped together without the use of many fastenings. Because the hopper vent 100 minimizes the use of fastenings, the hopper vent 100 preferably includes relatively few interior elements that may interfere with the passage of light through the exterior frame 110 or interior frame 120 of the hopper vent 100 or with the aesthetic appeal of the hopper vent 100.

In an alternative embodiment, the hopper vent 100 or other window may be mounted in an exterior wall. When mounted in an exterior wall, an opaque strip of material may be positioned around the perimeter of the exterior frame 110 of the hopper vent 100 to increase aesthetic appeal by preventing an observer from seeing through the exterior frame 110 and into the interior of the wall.

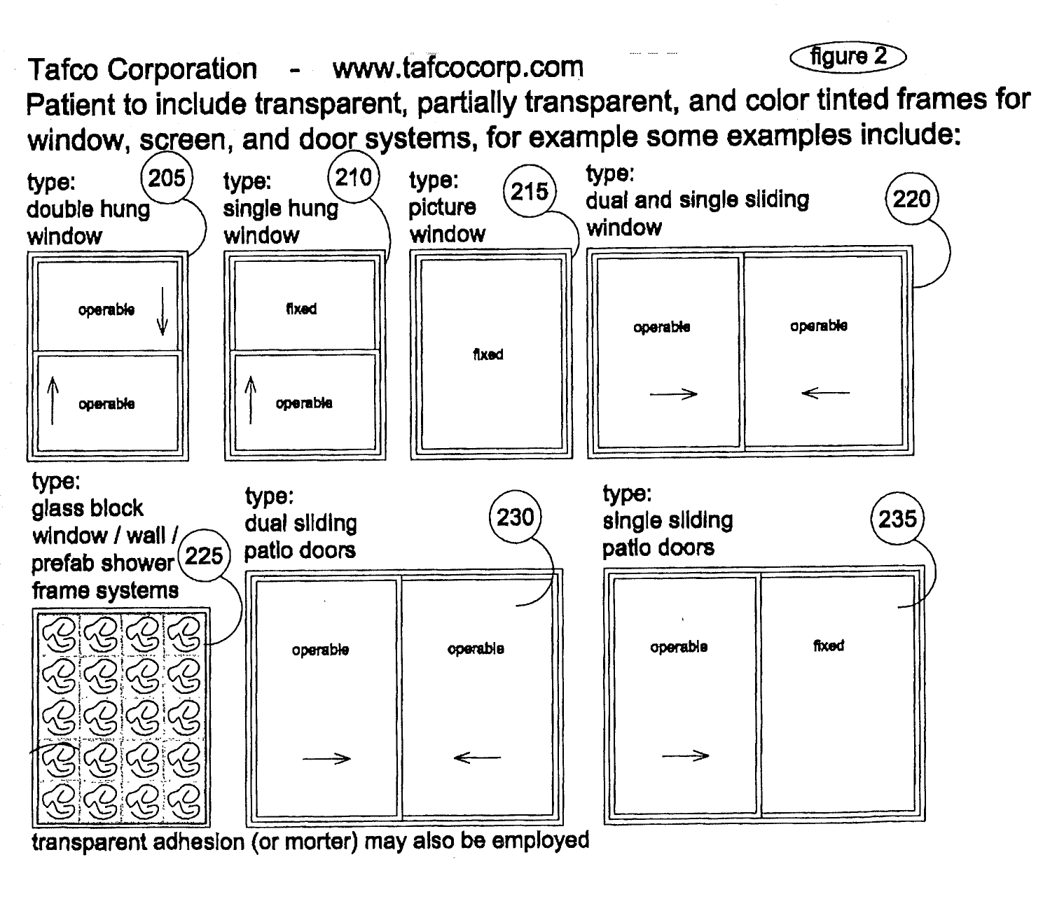

FIG. 2 illustrates several embodiments of non-opaque window framing systems for windows and doors according to the present invention. Examples shown in FIG. 2 include a double hung window 205, a single hung window 210, a picture window 215, a dual or single sliding window 220, a glass block window/wall/prefab shown frame system 225, a dual sliding patio door 230, and a single sliding patio door 235. The examples shown in FIG. 2 represent only a small number of the alternative embodiments of the present invention that may be developed by one skilled in the art.

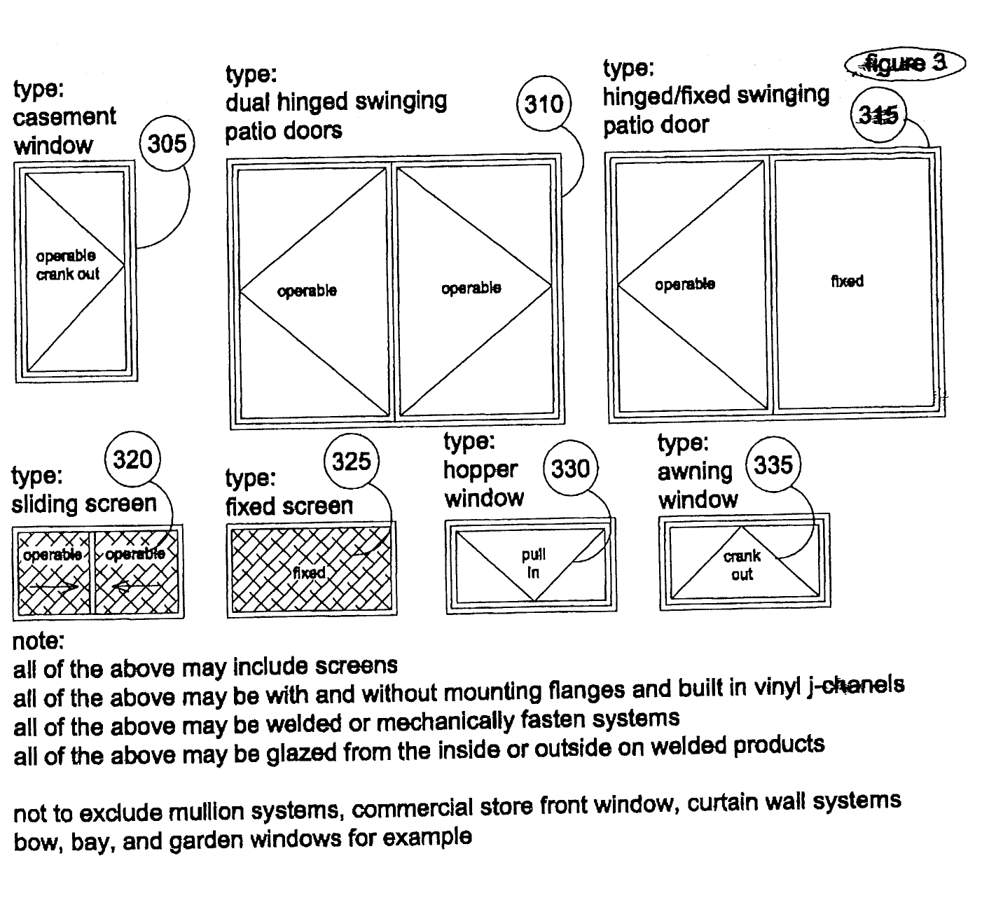

FIG. 3 illustrates additional embodiments of non-opaque window framing systems for windows and doors according to the present invention. Examples shown in FIG. 3 include a casement window 305, a dual hinged swinging patio door 310, a hinged/fixed swinging patio 315, a sliding screen 320, a fixed screen 325, a hopper window 330, and an awning window 335. The examples shown in FIG. 3 represent only a small number of the alternative embodiments of the present invention that may be developed by one skilled in the art.

LEXAN polycarbonate or other light permeable materials may have been previously employed in other fields, for example, commercially available photograph frames for framing photographs for display. However, the use of a transparent, tinted, or translucent material to form a window frame is new. Thus, the present invention includes the concept of maximizing light penetration through a window system while maintaining structural stability, environmental sealing, and aesthetic value.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A window frame for a window system, wherein said window frame is not opaque.

2. The window frame of claim 1, wherein said window frame is transparent.

3. The window frame of claim 1, wherein said window frame is translucent.

4. The window frame of claim 1, wherein said window frame is tinted.

5. The window frame of claim 1, wherein said window frame comprises LEXAN polycarbonate.

6. The window frame of claim 1, wherein said window frame comprises nylon.

7. The window frame of claim 1, wherein said window frame is formed using injection molding.

8. The window frame of claim 1, wherein said window frame is formed using extrusion.

9. A window system, said window system comprising:
a light permeable exterior frame;
a light permeable interior frame; and
a light permeable insert.

10. The window system of claim 9, wherein at least one of said exterior frame, said interior frame, and said insert are transparent.

11. The window system of claim 9, wherein at least one of said exterior frame, said interior frame, and said insert are translucent.

12. The window system of claim 9, wherein at least one of said exterior frame, said interior frame, and said insert are tinted.

13. The window system of claim 9, wherein at least one of said exterior frame, said interior frame, and said insert are comprised of one of LEXAN polycarbonate, nylon, and glass.

14. The window system of claim 9, further comprising a screen, wherein said screen is light permeable.

15. The window system of claim 9, further comprising an opaque strip along a perimeter of said exterior frame for obscuring vision through said exterior frame.

16. A method for providing increased light transmission through a window aperture, said method comprising:
providing a light permeable window frame to allow increased light transmission through said window aperture.

17. The method of claim 16, further comprising providing a light permeable screen.

18. The method of claim 16, wherein said providing step includes providing at least one of a light permeable exterior frame and a light permeable interior frame.

19. The method of claim 18, further comprising covering at least a portion of a perimeter of said exterior frame to obscure vision through said at least a portion of the perimeter of said exterior frame.

20. The method of claim 16, wherein said providing step includes providing a window frame that is one of transparent, translucent, and tinted.
